(19) United States
(12) Patent Application Publication
(10) Pub. No.: US 2020/0155928 A1
(43) Pub. Date: May 21, 2020

(54) GAMEPAD WITH DETACHABLE HANDGRIP

(71) Applicant: Shenzhen Saitake Electronic Co., Ltd., Shenzhen (CN)

(72) Inventor: SIMING GUO, Shenzhen (CN)

(21) Appl. No.: 16/215,674

(22) Filed: Dec. 11, 2018

(30) Foreign Application Priority Data
Nov. 15, 2018 (CN) 201821895542.X

(51) Int. Cl. A63F 13/24; A63F 13/98

(52) U.S. Cl. CPC A63F 13/24; A63F 13/98

(57) ABSTRACT

Provided is a gamepad with detachable handgrip which is related to the technical field of electronic products. The gamepad includes a holder and a left handgrip and a right handgrip that are respectively provided on left and right sides of the holder. The left handgrip and/or the right handgrip is detachably connected with the holder. By changing the fixed connection between the handgrip and the holder in traditional mobile phone gamepads and providing a detachable connection between at least one handgrip and the holder, users can replace the detachable handgrip with handgrips having different functions according to their own requirements. This helps to reduce the cost for users to buy gamepads and increases the flexibility of use of gamepads.

### CROSS REFERENCE TO RELATED APPLICATIONS

This application claims priority to Chinese Patent Application No. 201821895542.X, filed Nov. 15, 2018, which is hereby incorporated by reference herein as if set forth in its entirety.

### BACKGROUND

### 1. Technical Field

The present disclosure relates to the technical field of electronic products, and particularly to a gamepad with detachable handgrip.

### 2. Description of Related Art

With the popularization of portable electronic products such as smart phones, tablet computers and so on, and especially with the gradual rise of game software, typically mobile phone games, running on these electronic products, gamepads capable of providing players with better game experience also emerge. Take gamepads used with mobile phones to control mobile phone games, for example. Mobile phone gamepads at present are mainly divided into two types: nonfunctional gamepads and functional gamepads. A nonfunctional gamepad mainly includes a holder for placing a mobile phone, and handgrips provided on right and left sides of the holder for clamping and fixing of the mobile phone and for a user's easy holding of the mobile phone in palm. The handgrips are not provided with any functional operation keys for manipulating a game in the mobile phone (such handgrips can be construed as nonfunctional handgrips). The main purpose of such kind of gamepads is to make it easier for the user to hold the mobile phone and allow the user to use fingers to directly manipulate virtual operation keys displayed on the touch screen of the mobile phone. A functional gamepad, however, is provided on a handgrip thereof with functional operation keys capable of controlling a game in a mobile phone (such handgrip can be construed as a functional handgrip): signal transmission is realized by means of wired communication connection or wireless communication connection between the gamepad itself (especially the handgrip) and the mobile phone. Gamepads of this kind can use the functional operation keys to replace the virtual operation keys displayed on the touch screen of the mobile phone, thereby avoiding possible problems such as false operations and pollution to screen due to the direct contact between fingers and the touch screen.

However, structures of the above two types of gamepads are basically fixed, and the handgrips thereof are not interchangeable. When operating a game, a user can use either a nonfunctional gamepad or a functional gamepad. In this case, users cannot select and use a gamepad based on actual needs, which results in inferior user experience and may increase the cost for users to purchase gamepads.

### SUMMARY

In view of the abovementioned deficiencies of the existing technologies, the present disclosure aims to provide a gamepad with detachable handgrip.

In order to achieve the above objective, the present disclosure adopts the following technical solutions.

A gamepad comprises a holder and a left handgrip and a right handgrip that are respectively provided on a left side and a right side of the holder. The left handgrip and/or the right handgrip is detachably connected with the holder.

Preferably, the holder is provided at a left end face and/or a right end face thereof with a guide slide rail, and the left handgrip and/or the right handgrip is provided at an end face thereof with a guide slide groove used for the guide slide rail on a corresponding side to align therewith and fit thereinto.

Preferably, the holder comprises a main supporting base and a connection base provided on a right side of the main supporting base. The right handgrip is detachably connected with the main supporting base through the connection base, and the left handgrip is fixedly connected with the main supporting base. The guide slide rail is arranged at a right end face of the connection base, and the connection base is provided thereon with a positioning lock for locking the guide slide rail in the guide slide groove.

Preferably, the main supporting base is provided therein with at least one stretching slide groove along a right-left direction of the main supporting base. The left handgrip comprises a left handgrip shell and a first manipulation module mounted on the left handgrip shell. The left handgrip shell is provided at a right end face thereof with at least one left stretching arm that is inserted into the main supporting base from a left end of the main supporting base and is aligned with and fitted into the stretching slide groove. The connection base is provided at a right end face thereof with at least one right stretching arm that is inserted into the main supporting base from a right end of the main supporting base and is aligned with and fitted into the stretching slide groove. At least one of the left stretching arms is arranged to be in a transmission connection or elastic connection with a corresponding right stretching arm.

Preferably, an elastic connector is encapsulated in the main supporting base between a left stretching arm and its corresponding right stretching arm. The elastic connector is a tension spring or a coil spring, and provided is one or two elastic connectors. When provided is one elastic connector, one end of the elastic connector is connected with the left stretching arm, and the other end thereof is connected with the right stretching arm. When provided are two elastic connectors, one end of each elastic connector is connected with an inner wall of the main supporting base, and the other end thereof is correspondingly connected with the left stretching arm or the right stretching arm.

Preferably, the first manipulation module comprises a first driving control board and a first energy storage battery that are encapsulated in the left handgrip shell, and a first operation key set, a charging/data interface, and an onaoff switch that are embedded on a surface wall of the left handgrip shell. The first energy storage battery, the first operation key set, the charging/data interface, and the on/off switch are electrically connected with the first driving control board, respectively.

Preferably, the right handgrip comprises a right handgrip shell and a second manipulation module mounted on the right handgrip shell. The second manipulation module comprises a second driving control board and a second energy storage battery that are encapsulated in the right handgrip shell, and a second operation key set and a data plug that are embedded in a surface wall of the right handgrip shell. The second energy storage battery, the second operation key set, and the data plug are electrically connected with the second driving control board, respectively. The guide slide groove is provided at a left end face of the right handgrip shell. A third driving control board is encapsulated in the connection base, and the connection base is further provided in a surface wall thereof with a data interface which is electrically connected to the third driving control board and is used for the data plug to align therewith and insert thereinto.

Preferably, the holder comprises a main supporting base and two connection bases that are respectively arranged at a left side and a right side of the main supporting base and form a mirror image of each other. The left handgrip and the right handgrip are detachably connected with the main supporting base through the connection bases on respective sides. The guide slide rail is arranged at an end face of a corresponding connection base, and each connection base is provided with a positioning lock for locking the guide slide rail in a corresponding guide slide groove.

Preferably, the guide slide rail is arranged at an end face of the connection base along an up-down direction of the main supporting base and has a cross-section in a shape similar to the shape of the letter “T” in a right-left direction of the main supporting base. The guide slide groove is a groove structure that is formed by two guide clamping bars being in a shape similar to the shape of the letter “L” and being symmetrically arranged in a front-back direction at an end face of the left handgrip or the right handgrip together with the end face of the left handgrip or the right handgrip, and has a convex-type cross-section in a right-left direction of the main supporting base.

The positioning lock comprises an unlocking button penetrating through a rear wall surface of the connection base along a front-back direction of the connection base, a locking spring held between an inner end face of the unlocking button and the connection base, and a locking block formed around an inner end of the unlocking button to abut against a surface of the guide slide groove, and a locking hole is formed in a region where a longitudinal arm of the guide slide rail connects with the end face of the connection base for forward and backward feed movement of the locking block relative to the connection base.

By adopting the above solutions, the present disclosure changes the fixed connection between the handgrip and the holder in traditional mobile phone gamepads and provides a detachable connection between at least one handgrip and the holder, which allows users to replace the detachable handgrip with handgrips having different functions according to their own requirements. This helps to reduce the cost for users to buy gamepads and increases the flexibility of use of gamepads

### BRIEF DESCRIPTION OF THE DRAWINGS

FIG. 1 schematically shows a structural plan view of a first embodiment of the present disclosure.

FIG. 2 schematically shows a back assembly view of the embodiment of FIG. 1 in a folded state.

FIG. 3 schematically shows a structural front exploded view of a main body of the embodiment of FIG. 1 in an unfolded state.

FIG. 4 schematically shows a structural back exploded view of the main body of the embodiment of FIG. 1 in the unfolded state.

FIG. 5 schematically shows an assembly view of a connection base adopted in an embodiment of the present disclosure.

FIG. 6 schematically shows a structural exploded view of the connection base adopted in an embodiment of the present disclosure.

FIG. 7 schematically shows a structural exploded view of a left handgrip of the embodiment of FIG. 1.

FIG. 8 schematically shows a structural exploded view of a functional right handgrip adopted in an embodiment of the present disclosure.

FIG. 9 schematically shows a structural exploded view (A) of a nonfunctional right handgrip adopted in an embodiment of the present disclosure.

FIG. 10 schematically shows a structural exploded view (B) of the nonfunctional right handgrip adopted in an embodiment of the present disclosure.

FIG. 11 schematically shows a structural plan view of an embodiment of the present disclosure in which handgrips on both sides are detachable and both of the handgrips are functional.

FIG. 12 schematically shows a structural planar view of an embodiment of the present disclosure in which handgrips on both sides are detachable and one of the handgrips is nonfunctional and the other is functional.

FIG. 13 schematically shows a structural planar view of an embodiment of the present disclosure in which handgrips on both sides are detachable and both of the handgrips are nonfunctional.

### DETAILED DESCRIPTION

Embodiments of the present disclosure will be illustrated below in detail in conjunction with the accompanying drawings. The present disclosure, however, may be implemented in different ways as defined and covered by the claims.

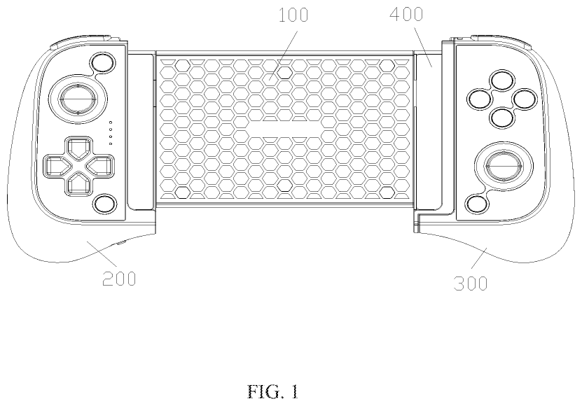

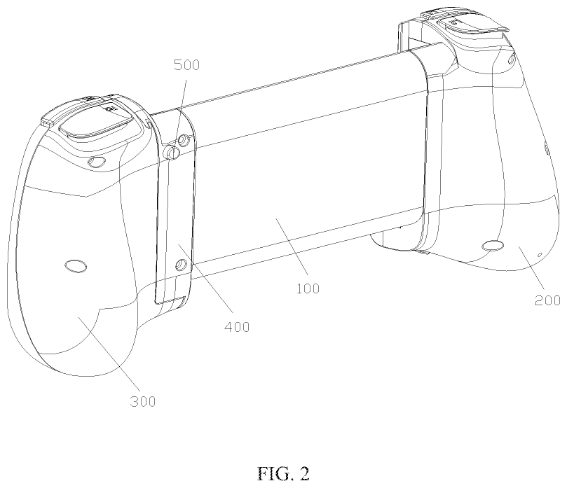

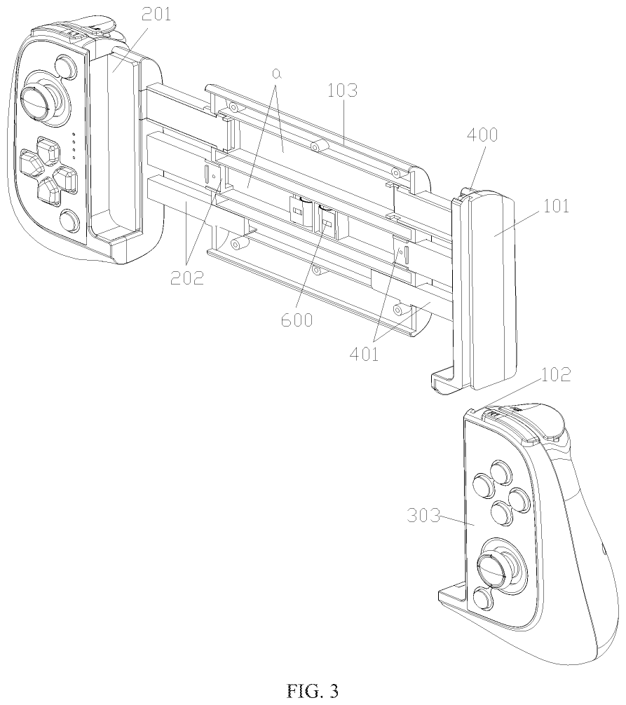

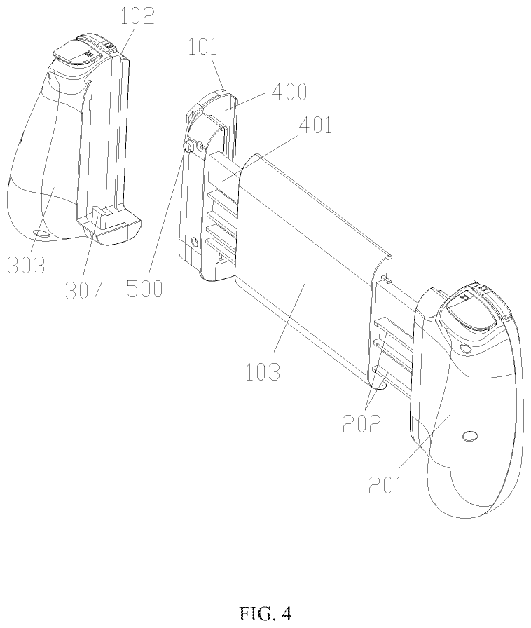

As shown in FIGS. 1-13, a gamepad provided by the present embodiment comprises a holder 100 for placing an electronic product such as a mobile phone, a tablet computer and the like, and a left handgrip 200 and a right handgrip 300 which are respectively provided on left and right sides of the holder 100 to secure the electronic product on the holder 100. The left handgrip 200 and/or the right handgrip 300 is detachably connected with the holder 100. By way of this, the fixed connection between the handgrip and the holder in the traditional mobile phone gamepad is changed, and at least one handgrip is detachably connected with the holder 100. This allows users to replace the detachable handgrip according to their own use requirements, thereby obtaining a gamepad with a combined structure of two functional handgrips plus the holder 100, or a combined structure of two nonfunctional handgrips plus the holder 100, or a combined structure of one functional handgrip plus one nonfunctional handgrip plus the holder 100. This helps to reduce the cost for users to buy gamepads and meanwhile increases the flexibility of use of gamepads. After a functional operation handgrip is mounted on the holder 100, a functional unit in the handgrip can be used to establish, for example, a wireless data communication connection between the gamepad and the electronic product, so as to realize the control of game software or the like in the electronic product. After a nonfunctional handgrip is mounted on the holder 100, the handgrip can be used to provide a space for holding of the electronic product by a user's palm, enabling the user to directly control the game software or the like in the electronic product by way of finger touch. In addition, it should be noted that the handgrip in this embodiment may be mounted to the holder 100 by mechanical connections such as clamping, locking and magnetic attraction.

As a preferred solution, in order to facilitate quick mounting of the detachable handgrip on the holder 100, the holder 100 is provided at a left end face and/or a right end face thereof with a guide slide rail 101, and accordingly, it is required that the left handgrip 200 and/or the right handgrip 300 is provided at an end face thereof with a guide slide groove 102 used for a guide slide rail on a corresponding side to align therewith and fit thereinto. A slide-type mounting and dismounting structure is thus formed between the handgrip and the holder 100, which allows replacement of a certain handgrip when needed. Of course, the guide slide groove 102 may also be provided on the holder 100 according to actual situations, and the guide slide rail 101 may be provided on a corresponding handgrip.

Based on the detachable structural relationship between the handgrip and the holder 100, the gamepad of this embodiment may be specifically implemented as follows.

FIGS. 1 to 4 show a first embodiment of a structure in which only the handgrip at one single side is detachable.

The holder 100 comprises a main supporting base 103 and a connection base 400 provided at a right end of the main supporting base 103. The right handgrip 300 is detachably connected with the main supporting base 103 through the connection base 400, and the left handgrip 200 is fixedly connected with the main supporting base 103. In this case, the guide slide rail 101 is arranged at a right end face of the connection base 400, and correspondingly, the guide slide groove 102 is arranged on a left end face of the right handgrip 300. Meanwhile, the connection base 400 can be provided with a positioning lock 500 for locking the guide slide rail 101 in the guide slide groove 102. An assembly structure in which the left handgrip 200 is non-detachable and the right handgrip 300 is detachable is thus formed. When it comes to the functionality setting of the gamepad, the left handgrip 200 can be designed to be a functional handgrip or a nonfunctional handgrip. Because the right handgrip 300 is detachable, the user can, if necessary, replace the right handgrip 300 with a functional handgrip or a nonfunctional handgrip which can be detachably mounted to or dismounted from the holder 100, thereby obtaining various structures such as a combined structure of two functional handgrips plus the holder 100, or a combined structure of two nonfunctional handgrips plus the holder 100, or a combined structure of a nonfunctional handgrip plus a functional handgrip plus the holder 100.

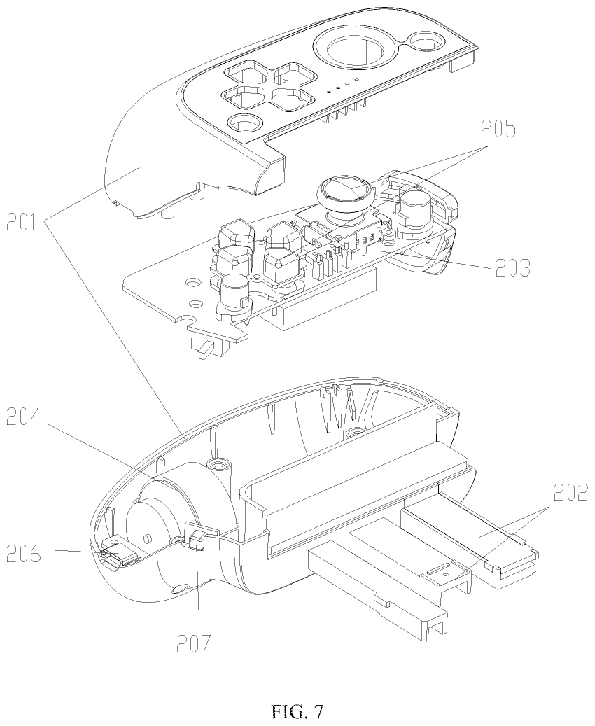

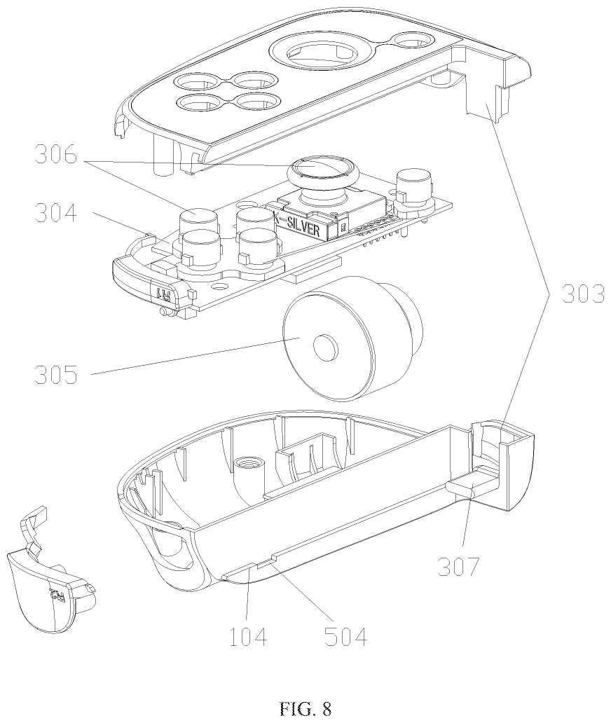

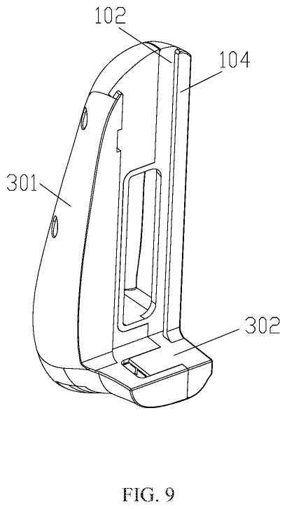

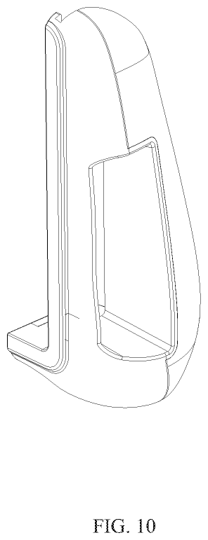

On the basis of the first embodiment, as a preferred solution, the left handgrip 200 of the embodiment adopts a functional handgrip (as shown in FIG. 7), and the right handgrip 300 adopts a functional handgrip (as shown in FIG. 8) or a nonfunctional handgrip (as shown in FIGS. 9 and 10) according to practical conditions. The main supporting base 103 is provided therein with at least one stretching slide groove a distributed in a right-left direction along the main supporting base 103. The left handgrip 200 includes a left handgrip shell 201 and a first manipulation module (whose main function is to control the game software and the like in an electronic product after it is connected to the electronic product for telecommunication) mounted on the left handgrip shell 201. At the same time, the left handgrip shell 201 is provided at a right end face thereof with at least one left stretching arm 202 that is inserted into the main supporting base 103 from a left end of the main supporting base 103 and is aligned with and fitted into the stretching slide groove a; the connection base 400 is provided at a right end face thereof with at least one right stretching arm 401 that is inserted into the main supporting base 103 from a right end of the main supporting base 103 and is aligned with and fitted into the stretching slide groove a; and at least one of the left stretching arms 202 is in a transmission connection or elastic connection with a corresponding right stretching arm 401. In this way, the transmission connection (e.g., gear mesh transmission) or elastic connection between the left stretching arm 202 and the right stretching arm 401 allows the left handgrip 200 and the connection base 400 as well as the right handgrip 300 mounted on the connection base 400 by means of the coordination between the guide slide rail and the guide slide groove to simultaneously contract towards or stretch from the holder 100 along the stretching slide groove a, so that users can place electronic products with different sizes on the holder 100 and clamp and fix the electronic products with the left and right handgrips. Of course, as a preferred solution, in order to maintain the stability of the left handgrip and the right handgrip during their contraction and stretching movement, in this embodiment, provided are three left stretching arms 202 and three right stretching arms 401 which are in one-to-one correspondences with each other. The three left stretching arms 202 are arranged parallel to each other in an up-down direction relative to the holder 100 (the three right stretching anus 401 are arranged based on a same structural principle). The left stretching arm 202 in the middle and the right stretching arm 401 in the middle are arranged to be in a transmission connection or in an elastic connection, and the left stretching arms 202 and the right stretching arms 401 on upper and lower sides are not connected with each other. Thus, the stretching arms on the upper and lower sides are used as auxiliary guide arms, and the stretching arms in the middle are used as power arms, by way of which the stability of movement of the handgrips and the connection base 400 is ensured. Of course, in order to enhance the firmness of the clamping of the electronic product by the handgrips, the left and right stretching arms on the upper and lower sides can also be arranged to be in a transmission or elastic connection.

In order to best simplify the structure of the entire gamepad and further enhance the firmness of the clamping of the electronic product by the left and right handgrips, an elastic connector 600 is provided and encapsulated in the main supporting base 103 and between a left stretching arm 202 and a corresponding right stretching arm 401. Based on actual conditions, the elastic connector 600 can be a tension spring with a central axis thereof being arranged along a direction parallel to an extending direction of the stretching slide groove a, or a coil spring with a central axis thereof being arranged along a direction perpendicular to the extending direction of the stretching groove a. Provided is one or two elastic connectors (namely the number of the elastic connectors provided between each left stretching arm 202 and its corresponding right stretching arm 401). When provided is one elastic connector 600, one end of the elastic connector 600 is connected with the left stretching arm 202, and the other end thereof is connected with the right stretching arm 401. When provided are two elastic connectors 600, one end of each elastic connector 600 is connected to an inner wall of the main supporting base 103, and the other end thereof is connected correspondingly to the left stretching arm 202 or the right stretching arm 401. Thus, due to the elastic contraction effect of the elastic connector 600, it can be ensured that the left handgrip 200, the connection base 400, and the right handgrip 300 can automatically contract after being stretched, and enough tension can therefore be generated to ensure the firm clamping of the electronic product by handgrips.

As shown in FIG. 7, the first manipulation module in the first embodiment comprises a first driving control board 203 and a first energy storage battery 204 that are encapsulated in the left handgrip shell 201, and a first operation key set 205 (which mainly consists of functional operation keys such as directional keys, universal rockers, etc., provided on conventional gamepads), a charging/data interface 206, and an on/off switch 207 that are embedded on a surface wall of the left handgrip shell 201. The first energy storage battery 204, the first operation key set 205, the charging/data interface 206, and the on/off switch 207 are electrically connected with the first driving control board 203, respectively. In this way, the first driving control board 203 can be used as a core control unit of the entire left handgrip 200 and can be used to carry out data communication connection with the electronic product. The charging/data interface 206 can be used to charge the first energy storage battery 204, and it can also be used to establish data communication connection between the first driving board 203 and the electronic product. The first operation key set 205 can be used to replace virtual functional keys displayed on a screen of the electronic product, thereby allowing the user not to control the electronic product and contents displayed thereon by finger touch. The on/off switch 207 can be used to switch on or switch off the entire left handgrip 200 through the first driving control board 203.

The right handgrip 300 in the first embodiment can be a nonfunctional handgrip as shown in FIGS. 9 and 10 according to actual conditions (The nonfunctional handgrip mainly comprises a handgrip main body 301 that is provided at a left end face thereof with a guide slide groove 102, and a handgrip protection plate 302 that is formed at an upper end or a lower end of the handgrip main body 301 and is arranged perpendicular to the guide slide groove 102. Of course, other structural forms of the guide slide groove 102 can also be formed by modifying the structure of existing nonfunctional handgrips). The right handgrip 300 can also be a functional handgrip as shown in FIG. 8, which comprises a right handgrip shell 303 and a second manipulation module mounted on the right handgrip shell 303. The second manipulation module comprises a second driving control board 304 and a second energy storage battery 305 that are encapsulated in the right handgrip shell 303, and a second operation key set 306 and a data plug 307 that are embedded in a surface wall of the right handgrip shell 303. The second energy storage battery 305, the second operation key set 306, and the data plug 307 are electrically connected with the second driving control board 304, respectively, and the guide slide groove 102 is provided at a left end face of the right handgrip shell 303. Accordingly, a third driving control board 402 is encapsulated in the connection base 400, and a data interface 403 is provided in a surface wall the connection base 400, the data interface 403 being electrically connected to the third driving control board 402 and being used for the data plug 307 to align therewith and insert thereinto. Thus, after the functional right handgrip 300 is mounted on the connection base 400 through the coordination between the guide slide groove 102 and the guide slide rail 101, the data plug 307 can be aligned with and inserted into the data interface 403, and after a communication connection is established between the functional right handgrip 300 and the electronic product through the third drive control board 402, the second driving control board 304 can be used to manipulate the electronic product, by way of which the user can control the electronic product and contents displayed thereon using the right handgrip 300. Meanwhile, the data plug 307 can also be used to connect the right handgrip 300 directly with an external power supply, so that the second energy storage battery 305 can be charged.

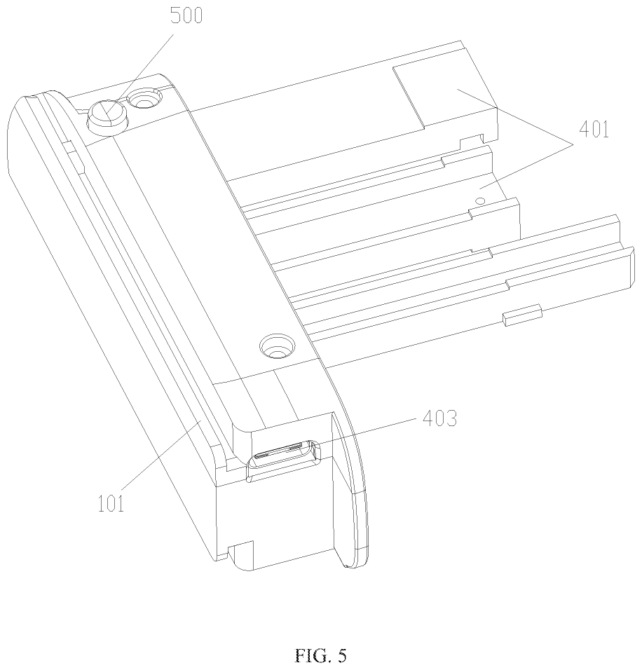

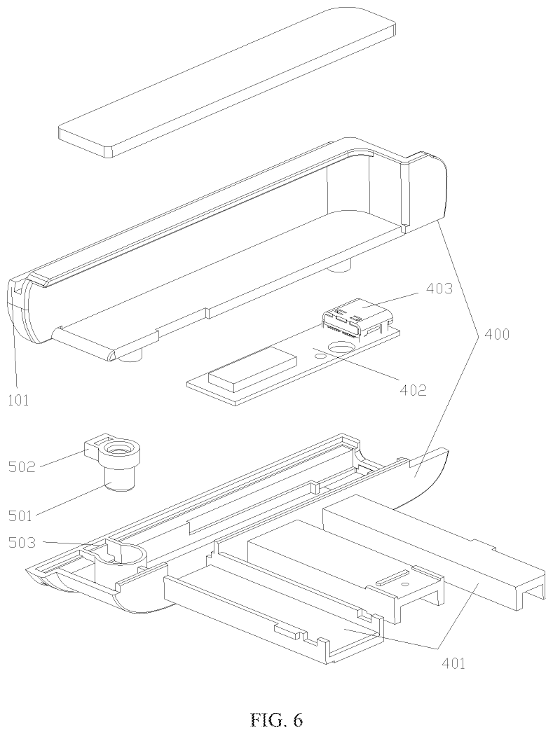

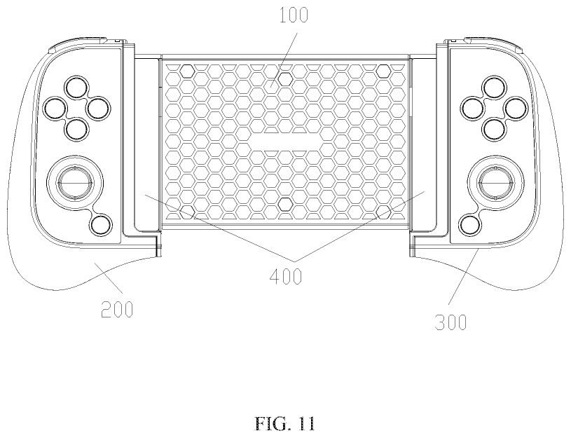

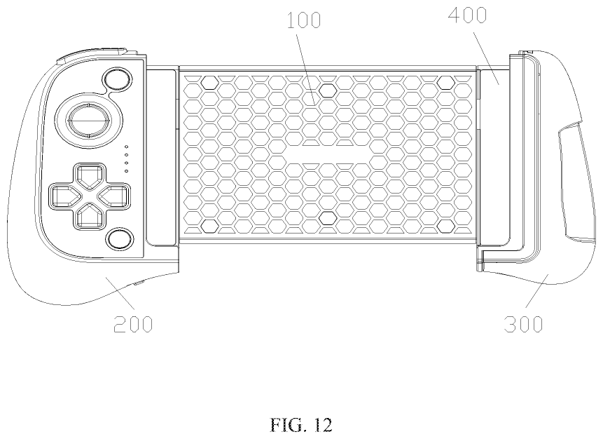

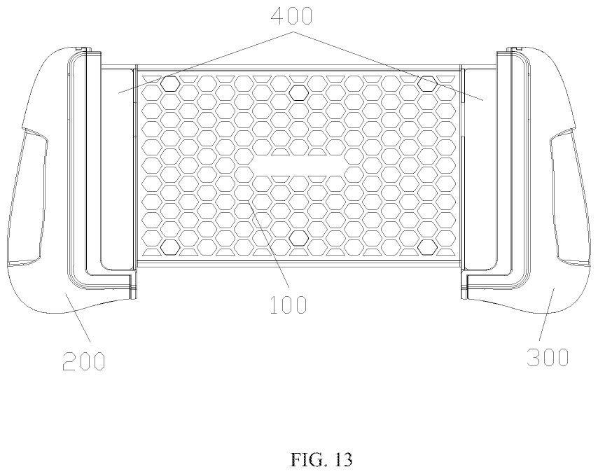

A second embodiment provides a structure as shown in FIG. 11 in which handgrips on both sides are detachable and both of the handgrips are functional, a structure as shown in FIG. 13 in which handgrips on both sides are detachable and both of the handgrips are nonfunctional, and a structure as shown in FIG. 12 in which handgrips on both sides are detachable and one of the handgrips is nonfunctional and the other is functional. The holder 100 comprises a main supporting base 103, and two connection bases 400 which are respectively arranged at a left side and a right side of the main supporting base 103 and form a mirror image of each other. The left handgrip 200 and the right handgrip 300 are detachably connected with the main supporting base 103 through the connection bases 400 on respective sides. The guide slide rail 101 is arranged at an end face of the connection base 400, and each connection base 400 is provided thereon with a positioning lock 500 for locking the guide slide rail 101 in a corresponding guide slide groove 102. Based on actual conditions, the left handgrip 200 and the right handgrip 300 can be a nonfunctional handgrip having a structure as shown in FIG. 5 or a functional handgrip having a structure as shown in FIG. 6, and the connection base 400 may take the same structural form as the connection base 400 in the first embodiment.

Of course, in order to ensure that the positioning lock 500 can firmly lock the handgrip on the connection base 400, the guide slide rail 101 of this embodiment is arranged at an end face of the connection base 400 along an up-down direction of the main supporting base 103, and has a cross-section in a shape similar to the shape of the letter “T” in a right-left direction of the main supporting base 103; the guide slide groove 102 is a groove structure that is formed by two guide clamping bars 104 being in a shape similar to the shape of the letter “L” and being symmetrically arranged in a front-back direction at an end face of the left handgrip 200 or the right handgrip 300 together with the end face of the left handgrip 200 or the right handgrip 300, and has a convex-type cross-section in the right-left direction of the main supporting base 103.

The positioning lock 500 comprises an unlocking button 501 penetrating through a rear wall surface of the connection base 400 along a front-back direction of the connection base 400, a locking spring (not shown in the figures) held between an inner end face of the unlocking button 501 and the connection base 400, and a locking block 502 formed around an inner end of the unlocking button 501 to abut against a surface of the guide slide groove 102. Besides, a locking hole 503 is formed in a region where a longitudinal arm of the guide slide rail 101 connects with the end face of the connection base 400 for forward and backward feed movement of the locking block 502 relative to the connection base 400. Thus, when the user pushes the unlocking button 501 to a predetermined position, the locking block 502 can be inserted into the locking hole 503 (under this circumstance, the locking spring is in a compressed state). Then the user can mount the handgrip onto the guiding slide rail 101 by means of the guide slide groove 102, and when the user releases the unlocking button 501, the locking block 502, under a restoring force of the locking spring, extends out of the locking hole 503 and protrudes from a surface of the guiding slide rail 101, thereby pressing the guiding slide rail 101 against the guiding slide groove 102, and realizing firm locking of the holding handgrip. Of course, a limiting hole 504 can be provided in the surface of the guide slide groove 102 for the locking block 502 to align therewith and fit thereinto, so as to ensure that the handgrip does not move after being locked. In addition, the guide slide rail 101 and the guide slide groove 102 which the guide slide rail 101 aligns with and fits into can also adopt other mortise or tenon structures according to actual situations, or can be formed by variation of the structures of the present embodiment.

The above descriptions are merely preferred embodiments of the present disclosure and do not therefore limit the protection scope of the present disclosure. All equivalent structures or equivalent processes obtained based on the description and drawings of the present disclosure or direct/indirect use thereof in other relevant technical fields shall fall within the protection scope of the present disclosure.

1. A gamepad, comprising a holder and a left handgrip and a right handgrip that are respectively provided on a left side and a right side of the holder, wherein the left handgrip and/or the right handgrip is detachably connected with the holder.

2. The gamepad of claim 1, wherein the holder is provided at a left end face and/or a right end face thereof with a guide slide rail, and the left handgrip and/or the right handgrip is provided at an end face thereof with a guide slide groove used for the guide slide rail on a corresponding side to align therewith and fit thereinto.

3. The gamepad of claim 2, wherein the holder comprises a main supporting base and a connection base provided on a side of the main supporting base, wherein the right handgrip is detachably connected with the main supporting base through the connection base, and the left handgrip is fixedly connected with the main supporting base.

4. The gamepad of claim 3, wherein the connection base is provided thereon with a positioning lock for locking the guide slide rail in the guide slide groove.

5. The gamepad of claim 4, wherein the main supporting base is provided therein with at least one stretching slide groove; the left handgrip comprises a left handgrip shell and a first manipulation module mounted on the left handgrip shell, wherein the left handgrip shell is provided at a right end face thereof with at least one left stretching arm that is inserted into the main supporting base from a left end of the main supporting base and is aligned with and fitted into the stretching slide groove; and the connection base is provided at a right end face thereof with at least one right stretching arm that is inserted into the main supporting base from a right end of the main supporting base and is aligned with and fitted into the stretching slide groove.

6. The gamepad of claim 5, wherein at least one of the left stretching arms is in a transmission connection or elastic connection with a corresponding right stretching arm.

7. The gamepad of claim 5, wherein an elastic connector is encapsulated in the main supporting base between a left stretching arm and its corresponding right stretching arm, and provided is one or two elastic connectors, wherein when provided is one elastic connector, one end of the elastic connector is connected with the left stretching arm, and the other end thereof is connected with the right stretching arm, and when provided are two elastic connectors, one end of each elastic connector is connected with an inner wall of the main supporting base, and the other end thereof is correspondingly connected with the left stretching arm or the right stretching arm.

8. The gamepad of claim 5, wherein the first manipulation module comprises a first driving control board and a first energy storage battery that are encapsulated in the left handgrip shell, and a first operation key set, a charging/data interface, and an on/off switch that are embedded on a surface wall of the left handgrip shell, wherein the first energy storage battery, the first operation key set, the charging/data interface, and the on/off switch are electrically connected with the first driving control board, respectively.

9. The gamepad of claim 5, wherein the right handgrip comprises a right handgrip shell and a second manipulation module mounted on the right handgrip shell, wherein the second manipulation module comprises a second driving control board and a second energy storage battery that are encapsulated in the right handgrip shell, and a second operation key set and a data plug that are embedded in a surface wall of the right handgrip shell, wherein the second energy storage battery, the second operation key set, and the data plug are electrically connected with the second driving control board, respectively, and the guide slide groove is provided at a left end face of the right handgrip shell; wherein a third driving control board is encapsulated in the connection base, and the connection base is further provided in a surface wall thereof with a data interface which is electrically connected to the third driving control board and is used for the data plug to align therewith and insert thereinto.

10. The gamepad of claim 2, wherein the holder comprises a main supporting base and two connection bases that are respectively arranged at a left side and a right side of the main supporting base and form a mirror image of each other, wherein the left handgrip and the right handgrip are detachably connected with the main supporting base through the connection bases on respective sides.

11. The gamepad of claim 10, wherein the guide slide rail is arranged at an end face of a corresponding connection base, and each connection base is provided thereon with a positioning lock for locking the guide slide rail in a corresponding guide slide groove.

12. The gamepad of claim 11, wherein the guide slide rail is arranged at an end face of the connection base along an up-down direction of the main supporting base and has a cross-section in a shape similar to the shape of the letter “T” in a right-left direction of the main supporting base.

13. The gamepad of claim 3, wherein the guide slide groove is a groove structure that is formed by two guide clamping bars being in a shape similar to the shape of the letter “L” and being symmetrically arranged in a front-back direction at an end face of the left handgrip or the right handgrip together with the end face of the left handgrip or the right handgrip, and has a convex-type cross-section in a right-left direction of the main supporting base.

14. The gamepad of claim 3, wherein the positioning lock comprises an unlocking button penetrating through a rear wall surface of the connection base along a front-back direction of the connection base, a locking spring held between an inner end face of the unlocking button and the connection base, and a locking block formed around an inner end of the unlocking button to abut against a surface of the guide slide groove, and a locking hole is formed in a region where a longitudinal arm of the guide slide rail connects with the end face of the connection base for forward and backward feed movement of the locking block relative to the connection base.
